(19) United States
(12) Patent Application Publication
(10) Pub. No.: US 2015/0360442 A1
(43) Pub. Date: Dec. 17, 2015

(54) COMPOSITE BONDED LEATHER CASES

(71) Applicant: Apple Inc., Cupertino, CA (US)

(72) Inventors: Benjamin M. Rappoport, San Francisco, CA (US); James A. Stryker, Mountain View, CA (US)

(21) Appl. No.: 14/304,620

(22) Filed: Jun. 13, 2014

Related U.S. Application Data
(63) Continuation of application No. PCT/US14/42256, filed on Jun. 13, 2014.

(51) Int. Cl. B32B 9/02; B32B 5/02; B32B 3/30; B29C 43/14

(52) U.S. Cl. CPC B32B 9/025; B29C 43/146; B32B 5/02; B32B 3/30; B29K 2101/00

(57) ABSTRACT

Methods and computer program products for forming a composite structure are provided. The composite structure may include a first molded layer and a second molded layer. The molded layers may include leather particles, a binding agent, and structural fibers. Thereby, the composite structure may define a look and feel similar to natural sheets of leather. An intermediate member may be positioned between the first molded layer and the second molded layer to provide certain specified additional functionality such as bending resistance.

### CROSS-REFERENCE TO RELATED APPLICATION(S)

This application is a continuation of International Application PCT/US14/42256, with an international filing date of Jun. 13, 2014, entitled “COMPOSITE BONDED LEATHER CASES,” which is incorporated herein by reference in its entirety.

### FIELD

The present disclosure relates generally to composite structures, and more particularly to composite structures formed from leather.

### BACKGROUND

In recent years the usage of protective covers and cases for electronic devices has become popular. Such covers and cases may protect the electronic device from damage. For example, such covers and cases may protect a screen of the electronic device such that scratches thereon may be avoided. Further, breakage of the screen may be resisted when the cover or case extends over or proud of the screen. Additionally or alternatively, covers and cases may protect a housing of the electronic device. Thereby, for example, covers and cases may provide a degree of added shock resistance which may protect the internal components of the electronic device. Additionally, some cases and covers may provide a cleaning function by rubbing against and removing contaminants from the screen of the device. Further, such cases and covers may be configured to function as a stand or other positioning device that facilitates usage of the electronic device.

As may be understood, the external appearance of the electronic device may be of concern to some users. In this regard, a user may prefer to use a cover or case only if the cover or case provides a pleasing aesthetic appearance. Thus, leather has been employed to form some cases or covers. Leather may provide a desired aesthetic appearance while also providing a desired degree of durability and shock resistance.

However, the production of covers and cases from leather may present certain manufacturing challenges. In this regard, the formation of leather sheets into covers and cases may involve certain stretching and adhesion operations to define a desired shape. These operations may be relatively time consuming and delicate, such that the production of covers and cases from leather is relatively expensive.

Accordingly, the present disclosure is directed to the production of composite structures formed from leather.

### SUMMARY

Methods and computer program products provided herein may be employed to form three-dimensional composite structures. The composite structure may be formed from a first mixture and a second mixture. The mixtures may be the same or different depending on the desired properties of the composite structure. The first mixture may be compression molded into a first molded layer. The second mixture may be molded into a second molded layer. First and second upper mold members may be employed to form the first molded layer and the second molded layer.

An intermediate member may be positioned between the first and second molded layers. The intermediate member may be a magnet or directional fibers that resist bending in certain directions but allow bending in others. Further, the compression molding process may cause the first molded layer and the second molded layer to include certain features defined therein, such as indentations, that form hinges or provide other functions. The resultant composite structure may resemble a product formed from natural leather, but do to formation via the molding process, complex shapes may be defined relatively easily.

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, assemblies, methods, and systems. These drawings in no way limit any changes in form and detail that may be made to the disclosure by one skilled in the art without departing from the spirit and scope of the disclosure.

FIG. 1 schematically illustrates a mixer configured to produce a mixture according to an example embodiment of the present disclosure;

FIG. 2 illustrates a sectional view through a mold including a mold member according to an example embodiment of the present disclosure;

FIG. 3 illustrates the mold of FIG. 2 including a first mixture in the mold member according to an example embodiment of the present disclosure;

FIG. 4 illustrates the mold of FIG. 2 including a first mating mold member, the mold member, and the first mixture according to an example embodiment of the present disclosure;

FIG. 5 illustrates the mold of FIG. 2 including the first mating mold member in engagement with the mold member and the first mixture therebetween according to an example embodiment of the present disclosure;

FIG. 6 illustrates the mold of FIG. 2 including a first molded layer in the mold member according to an example embodiment of the present disclosure;

FIG. 7 illustrates the mold of FIG. 2 including magnets positioned in contact with the first molded layer in the mold member according to an example embodiment of the present disclosure;

FIG. 8 illustrates the mold of FIG. 2 including the magnets and directional fibers positioned in contact with the first molded layer in the mold member according to an example embodiment of the present disclosure;

FIG. 9 illustrates the mold of FIG. 2 including a second mixture in contact with the magnets and directional fibers positioned in contact with the first molded layer in the mold member according to an example embodiment of the present disclosure;

FIG. 10 illustrates the mold of FIG. 2 including a second mating member, the second mating member being out of contact with a second mixture in contact with the magnets and directional fibers positioned in contact with the first molded layer in the mold member according to an example embodiment of the present disclosure;

FIG. 11 illustrates the mold of FIG. 2 wherein the second mating member is in contact with the mold member, the second mixture being in contact with the magnets and directional fibers positioned in contact with the first molded layer in the mold member according to an example embodiment of the present disclosure;

FIG. 12 illustrates the mold of FIG. 2 wherein a second molded layer and the first molded layer encloses the magnets and the directional fibers within the mold member according to an example embodiment of the present disclosure;

FIG. 13 illustrates a composite structure formed from the mold of FIG. 2 and comprising the first molded layer, the second molded layer, the magnets, and the directional fibers according to an example embodiment of the present disclosure;

FIG. 14 schematically illustrates a method for forming a composite structure according to an example embodiment of the present disclosure; and

FIG. 15 schematically illustrates a block diagram of an electronic device according to an example embodiment of the present disclosure.

### DETAILED DESCRIPTION

Representative applications of systems, apparatuses, computer program products and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

As described in detail below, the following relates to a two-stage molding process for forming composite structures from leather. The process may be configured to provide the appearance and benefits of leather while avoiding certain detriments. In this regard, it is hard to shape leather and much scrap leather may be produced. Further, creation of products from sheets of leather may result in undesirable seams.

Thus, the molding process may include a first stage wherein a first mixture comprising leather particles, a binding agent, and structural fibers form a first molded layer. After the first molded layer is formed, an intermediate member may be deposited in contact therewith. The intermediate member may include a magnet, mesh, a plate, directional fibers, and/or other items configured to provide certain functionality depending on the final resultant product.

A second molding stage may produce a second molded layer that is engaged with, and positioned on top of the intermediate member and the first molded layer. Accordingly, the intermediate member may be encapsulated between the first molded layer and the second molded layer, providing the resultant composite structure with a continuous, integral appearance. The second molded layer may be formed from a second mixture that may be the same as, or different than, the first mixture. Thus, the molded layers may define the same or differing material properties. Accordingly, a wide variety of cases, covers, housings, and other items may be formed from the molding process and defined by the composite structure.

These and other embodiments are discussed below with reference to the figures. However, those skilled in the art will readily appreciate that the detailed description given herein with respect to these figures is for explanatory purposes only.

Covers and cases are frequently employed to protect a large variety of electronic device including, for example, phones, smartphones, personal digital assistants, tablet computing devices, laptop computers, etc. Often the cases and covers include a cosmetic outer wrap, a structural shell, an inner wrap, ferrous or magnetic materials, and stiffening plates. Use of leather in such cases and covers may be desirable in some instances. In this regard, leather may provide a desirable aesthetic appearance while also providing desirable water resistance, durability, and shock resistance qualities. Thus, the outer wrap may include one or more sheets of leather in some embodiments.

However, cases and covers for electronic devices often define complex geometries in order to properly fit a corresponding device. Accordingly, one or more sheets of leather may be stretched and affixed to define a desired shape during manufacture of such cases and covers. These operations may be time consuming an expensive. Additionally, use of one or more sheets of leather may result in an exposed seam that negatively impacts the aesthetic appearance of the cover or case.

Further, the stretching operations employed in forming a case or cover having a desired shape may result in the case or cover having residual stresses in certain areas that may prematurely wear, deteriorate, or fail during usage thereof. The production of cases or covers from leather may also result in wasted leather material. In this regard, the sheets of leather may be cut to define a pattern that may be formed into a desired shape. Accordingly, depending on the shape of the cover or the case, the various scrap pieces of leather may define shapes or sizes that are not useable for the production of other items.

However, as a result of the desirable properties of leather itself, usage of leather in the formation of cases, covers, and other components may still remain desirable. In this regard, embodiments of the present disclosure are directed to methods and computer program products for the formation of composite structures from leather. Additionally, composite structures comprising leather are provided herein.

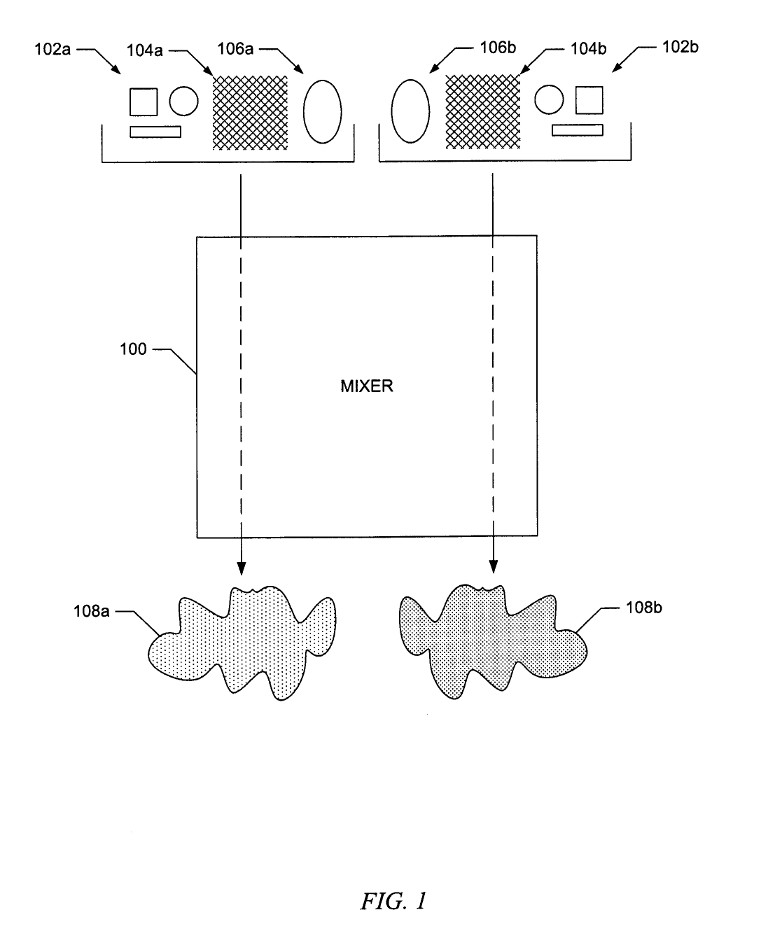

In this regard, FIG. 1 schematically illustrates a mixer 100 configured to produce mixtures employed in the formation of a composite structure. As illustrated, the mixer 100 may be configured to receive leather 102a, a plurality of structural fibers 104a, and a binding agent 106a. The leather 102a (e.g., natural leather) may include a plurality of scrap pieces of leather, shredded leather, or leather in any other form. Thus, the leather may be recycled in some embodiments. In this regard, the mixer 100 may be configured to grind or otherwise separate the leather 102a into a plurality of leather particles. Further, the structural fibers 104a may include any of various embodiments of fibrous materials configured to provide strength and structure. For example, the structural fibers 104a may include carbon, a liquid crystal polymer (LCP) such as VECTRAN®, para-aramid synthetic fibers (e.g., KEVLAR®), fiberglass, aramid, etc.

The binding agent 106a may include any of various binding agents configured to cure or set when exposed to a molding process, as described hereinafter. For example, the binding agent 106a may include a latex-based adhesive, an epoxy-based adhesive, or a contact cement (e.g., BARGE INFINITY CEMENT™). In some embodiments the binding agent 106a may be configured to be deactivated, for example through the application of heat or a release agent), to facilitate recycling of the leather 102a employed in any components produced therefrom at a later time.

Accordingly, the mixer 100 may mix the leather 102a, the structural fibers 104a, and the binding agent 106a to produce a mixture 108a. As noted above, the mixer 100 may be configured to grind or otherwise process the leather 102a into a plurality of leather particles having a substantially uniform size and shape. Accordingly, the resulting mixture 108a may be pourable and configured for molding.

As further illustrated in FIG. 1, in some embodiments the mixer 100 may be configured to produce a second mixture 108b. In this regard, as described below, the second mixture 108b may additionally be employed to form a composite structure. Accordingly, the mixture 108a is referred to hereinafter as a first mixture 108a. As described below, the second mixture 108b may be the same as, or different than, the first mixture 108a.

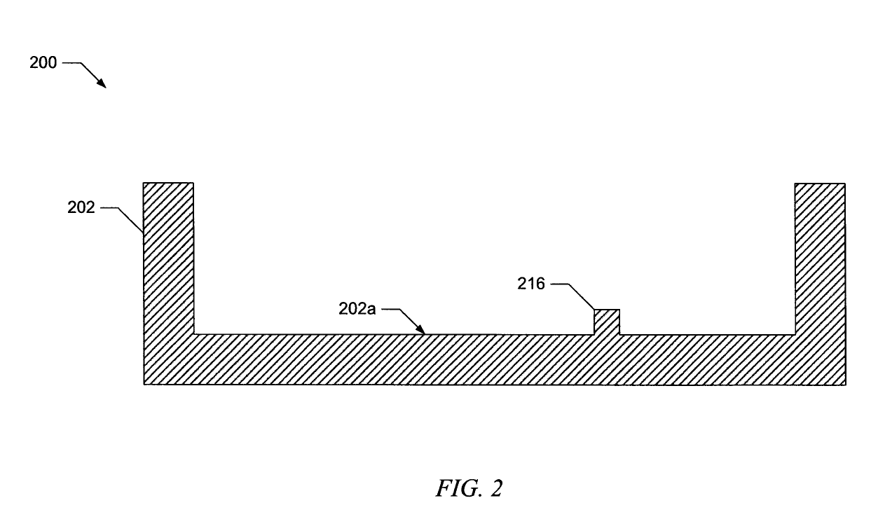

In this regard, FIGS. 2-12 illustrate sectional views through a mold 200 configured to form a composite structure according to an example embodiment of the present disclosure. The mold 200 may be configured to conduct a compression molding process wherein heat and pressure are employed to mold materials. Note that the dimensions of the mold 200 and the resulting composite structure are exaggerated in certain respects for illustration purposes. Further, it should be understood that the particular shape of the mold 200 and the resulting composite structure may vary and each may be configured to produce a desired shape depending on the desired final product.

Although the described embodiment incorporate a compression molding process, in other embodiments, a reaction injection molding (RIM) process is used to form the composite structure. This may involve a chemical reaction when liquid polymers are injected into a heated mold. Still, in other embodiments, a liquid injection molding (LIM) process is used to form the composite structure. This may involve mechanical mixing of elastomeric materials. Also, in other embodiments, the composite structure is formed from a resin impregnation process using resin for sealing components formed from casting. Also, in other embodiments, a transfer molding process is used to form the composite structure. This may involve premeasuring the amount of molding material before a molding process.

As illustrated in FIG. 2, the mold 200 may include a mold member 202. The mold member 202 may be referred to as a bottom mold member in some embodiments. In this regard, as described hereinafter, the mold member 202 may be configured as a bottom portion of the mold 200.

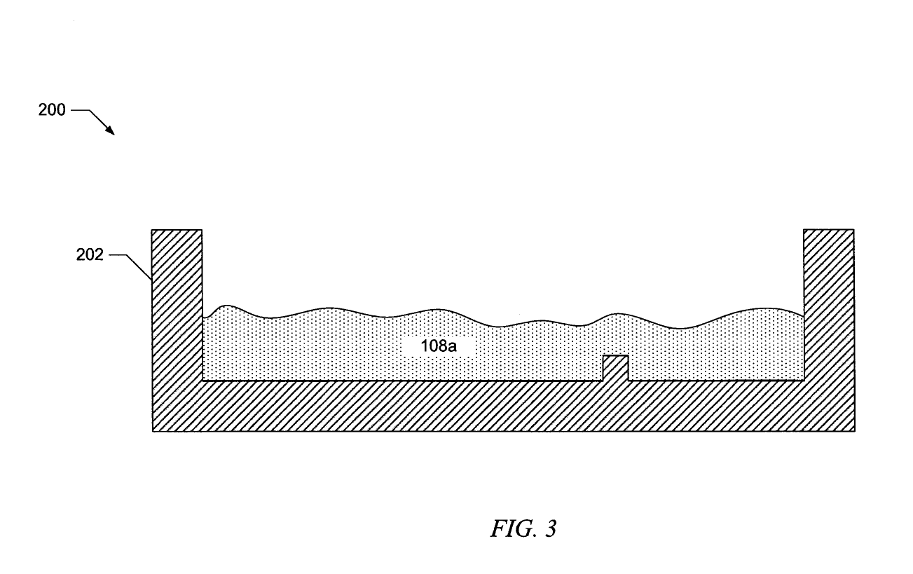

The mold member 202 may be configured to receive the first mixture 108a therein, as illustrated in FIG. 3. In this regard, the first mixture 108a may be poured our otherwise deposited therein. Thus, the first mixture 108a may conform to the shape defined by the mold member 202.

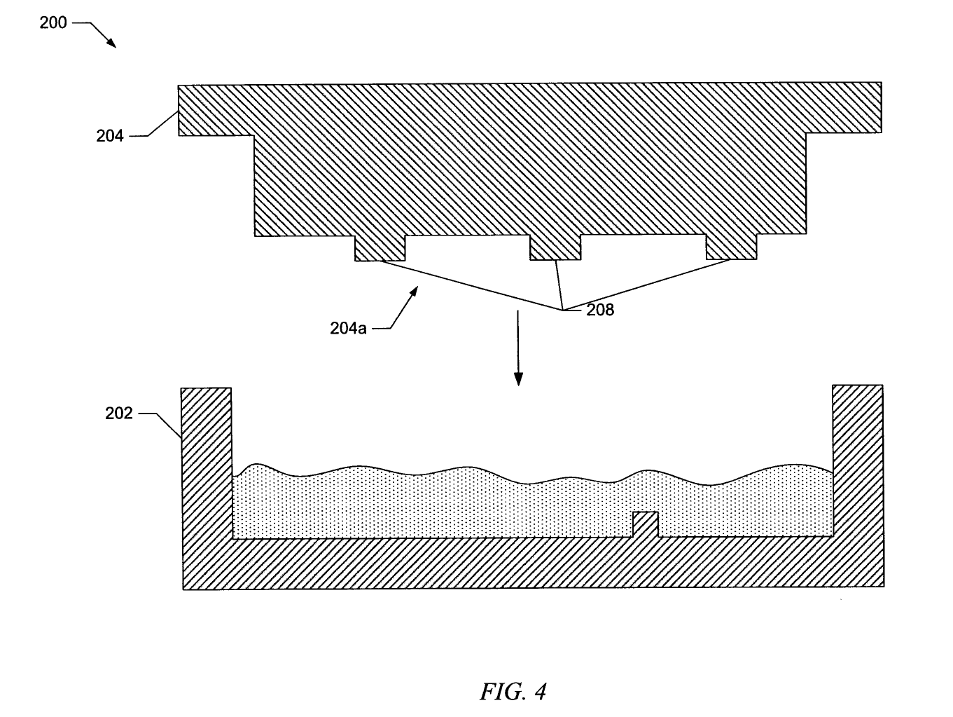

As illustrated in FIG. 4, the mold 200 may further include a first mating mold member 204. The first mating mold member 204 may be referred to as a first top mold member in some embodiments. In this regard, the first mating mold member 204 may be configured as a first top portion of the mold 200.

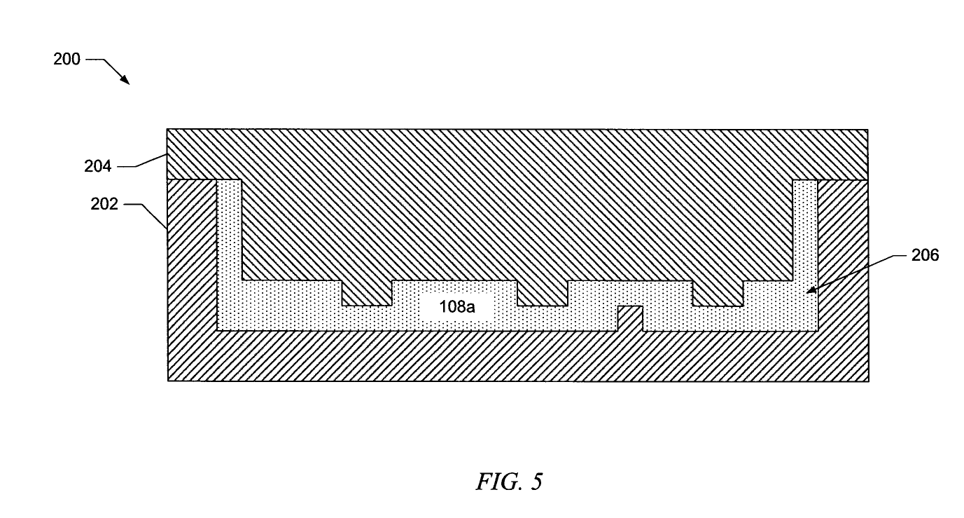

The mold member 202 and the first mating mold member 204 may be configured to compression mold the first mixture 108a therebetween, as illustrated in FIG. 5. Thus, the first mixture 108a may additionally conform to the shape of the first mating mold member 204. Accordingly, the first mixture 108a may conform to a shape of a first cavity 206 defined between the mold member 202 and the first mating mold member 204 during the compression molding process.

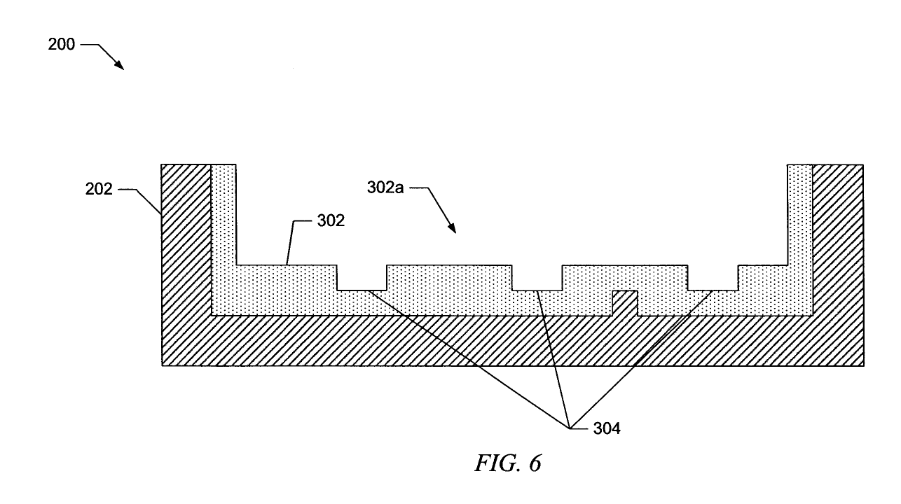

Thereafter, the first mating mold member 204 may be released from the mold member 202. Thereby, as illustrated in FIG. 6, a first molded layer 302 comprising the first mixture 108a, in a bonded and molded form, may be defined. As a result of the compression molding process, the first molded layer 302 may retain its form, despite the first mating mold member 204 being removed therefrom.

Thus, the shape of a first surface of the first molded layer 302, referred to hereinafter as an upper surface 302a for purposes of simplicity based on the illustrated example orientation, may define a configuration dictated by a molding surface 204a (see, FIG. 4) of the first mating mold member 204. In this regard, in the illustrated embodiment the first molded layer 302 includes a plurality of pockets 304 defined therein. The pockets 304 may be defined by a plurality of first mating protrusions 208 extending from the molding surface 204a (see, FIG. 4) of the first mating mold member 204.

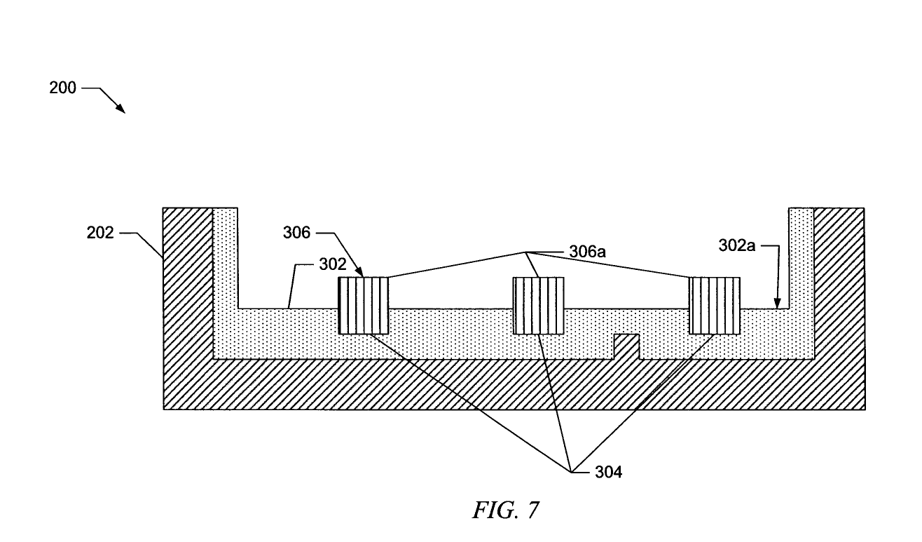

In some embodiments one or more intermediate members may be deposited in contact with the first molded layer 302. More particularly, in terms of the illustrated orientation, the intermediate members may be deposited in contact with the upper surface 302a of the first molded layer 302. Use of one or more intermediate members may provide the resultant composite structure with increased functionality and/or enhanced strength. In this regard, FIG. 7 illustrates an intermediate member 306 comprising a plurality of magnets 306a respectively received in one of the pockets 304. As may be understood, the magnets 306a may be configured to releasably engage the resultant composite structure with an electronic device, provide a releasable latch, and/or perform various other functions.

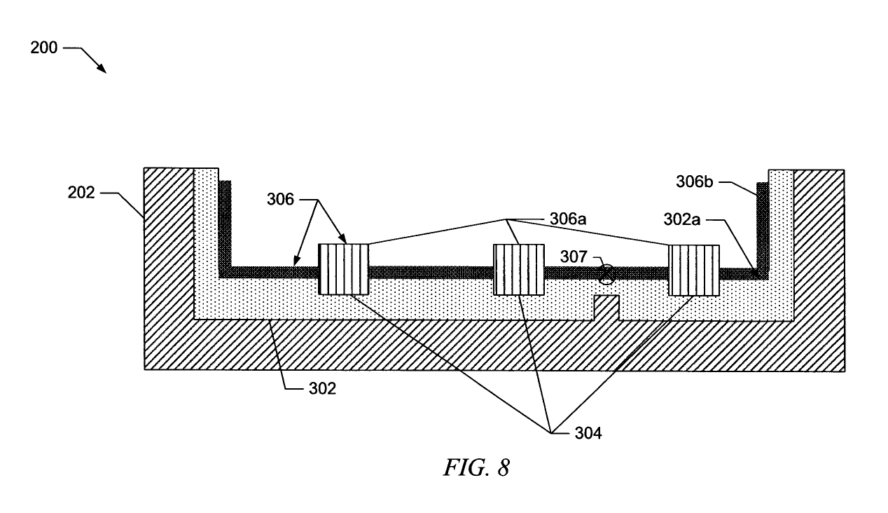

As noted above, in some embodiments more than one intermediate member 306 may be employed. In this regard, FIG. 8 illustrates an embodiment in which the intermediate member 306 further includes a plurality of directional fibers 306b. The directional fibers 306b may be substantially aligned with one another. By configuring the directional fibers 306b such that they are substantially aligned with one another, the directional fibers may be configured to selectively resist bending of the resultant composite structure in some directions while allowing bending in other directions.

In this regard, the directional fibers 306b may be aligned with a neutral axis 307 of the resultant composite structure. By way of example, in the illustrated embodiment the directional fibers 306b may be deposited in contact with the first molded layer 302 such that directional fibers extend substantially into the page, in terms of the illustrated orientation, in substantial alignment with the neutral axis 307, which additionally extends into the page. In this regard, the resultant composite structure may be configured to bend about the neutral axis 307, as described below. Accordingly, the resultant composite structure may be strengthened by the directional fibers 306b such that bending in directions other than about the neutral axis 307 may be resisted.

As may be understood various other embodiments of intermediate members may be deposited in contact with the first molded layer 302. Various example embodiments of intermediate members may include a ferromagnetic items such as a magnet or magnetic chips, a plurality of directional fibers, a plate, a mesh, metallic chips, a radio-frequency identification (RFID) tag, and a circuit board. Whereas the directional fibers may be configured to allow bending about a neutral axis and resist bending in other directions, usage of a plate or a mesh may resist bending in multiple directions. Further, the plate, metallic chips, or mesh may provide electromagnetic shielding in order to further protect an electronic device with the resultant composite structure. The RFID tag may be used for various purposes such as identification of the composite structure and theft prevention thereof. Additionally, the circuit board may be configured to provide any functionality such as control over a screen or light emitting diode (LED) additionally embedded in or connected to the resultant composite structure.

As noted above, the composite structure may additionally include the second mixture 108b. As illustrated in FIG. 1, in one embodiment the second mixture 108b may be produced from leather 102b, a plurality of structural fibers 104b, and a binding agent 106b. In one embodiment the leather 102b, the structural fibers 104b, and the binding agent 106b may be the same as the leather 102a, the structural fibers 104a, and the binding agent 106a employed to form the first mixture 108a. However, in other embodiments the second mixture 108b may include differing materials or materials in differing proportions such that the second mixture differs from the first mixture 108a. Accordingly, as described below, the first mixture 108a and the second mixture 108b may be configured to define differing properties in some embodiments following respective molding processes. Regardless, as further illustrated in FIG. 1, in some embodiments the mixer 100 may be employed to mix the components to form the second mixture 108b, or a separate mixer may be employed.

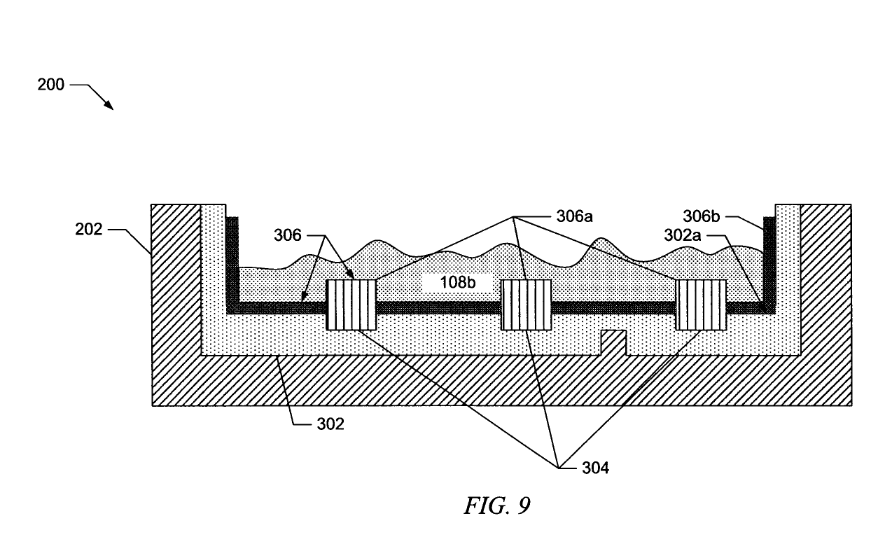

Thus, after the one or more intermediate members 306 are deposited in contact with the first molded layer 302, the second mixture 108b may also be deposited in contact with the first molded layer, as illustrated in FIG. 9. In this regard, the second mixture 108b may be poured our otherwise deposited in the mold member 202 on the upper surface 302a of the first molded layer 302 and/or the intermediate members 306, in terms of the illustrated orientation. Accordingly, the second mixture 108b may additionally or alternatively be deposited in contact with the intermediate members 306. Thus, the second mixture 108b may conform to the shape defined by the first molded layer 302, the intermediate member 306, and/or the mold member 202.

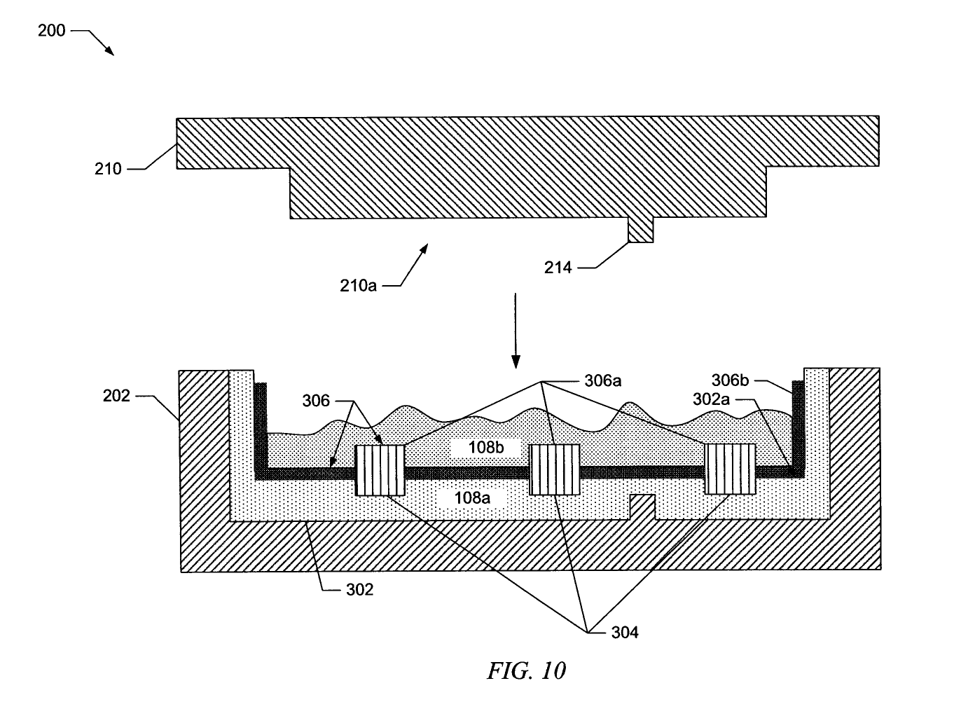

As illustrated in FIG. 10, the mold 200 may further include a second mating mold member 210. The second mating mold member 210 may be referred to as a second top mold member in some embodiments. In this regard, as described hereinafter, the second mating mold member 210 may be configured as a second top portion of the mold 200.

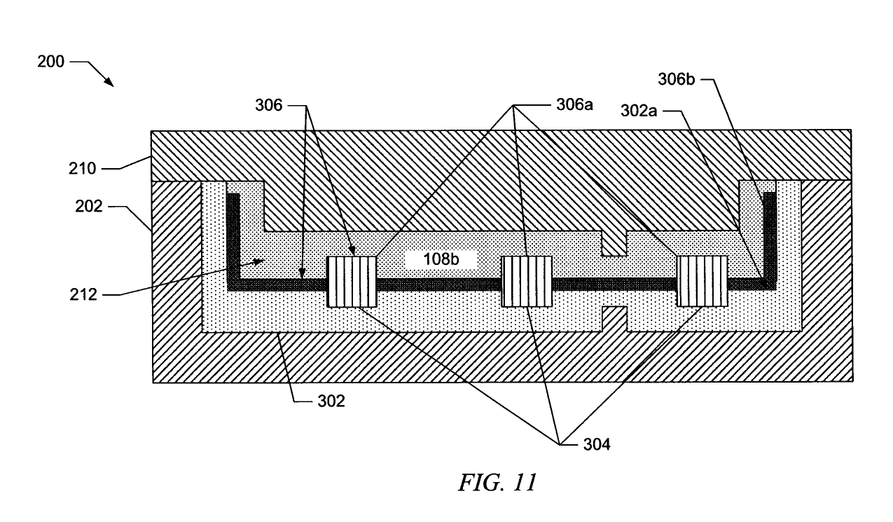

The mold member 202 and the second mating mold member 210 may be configured to compression mold the second mixture 108b therebetween, as illustrated in FIG. 11. Thus, the second mixture 108b may additionally conform to the shape of the second mating mold member 210. Accordingly, the second mixture 108b may conform to a shape of a second cavity 212 defined between the mold member 202 and the second mating mold member 210 during the compression molding process.

More particularly, the second cavity 212 may be defined between the first molded layer 302 and the second mating mold member 210 and the second mixture 108b may be compression molded therebetween. In this regard, the first molded layer 302 and/or the intermediate member 306 may define a boundary of the second cavity 212 in which the second mixture 108b is compression molded. Accordingly, the first molded layer 302 and/or the intermediate member 306 may define a portion of the mold 200, supported by the mold member 202, which compression molds the second mixture 108b in cooperation with the second mating mold member 210.

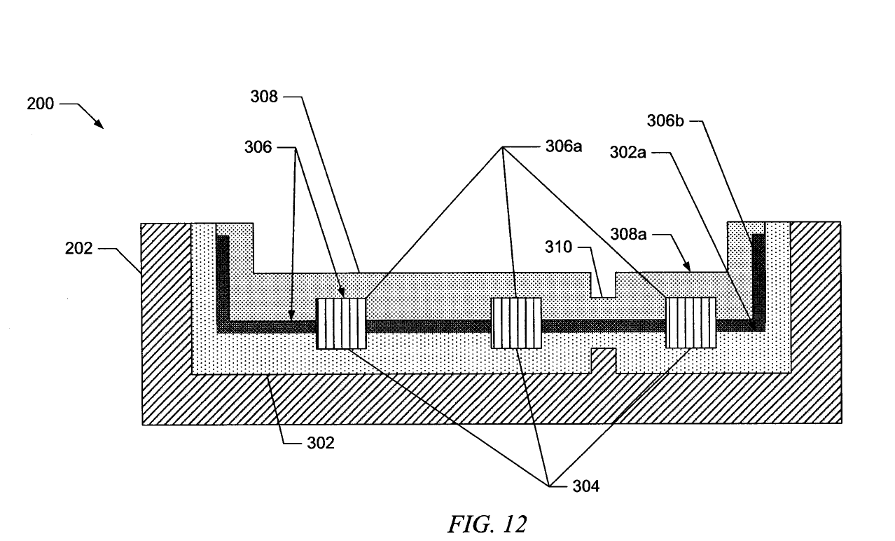

Thereafter, as illustrated in FIG. 12, the second mating mold member 210 may be released from the mold member 202. Thereby, a second molded layer 308 comprising the second mixture 108b, in a bonded and molded form, may be defined. As a result of the compression molding process, the second molded layer 308 may be coupled to the first molded layer 302, with the intermediate member 306 positioned between and substantially enclosed by the first molded layer and the second molded layer. Thus, use of a separate adhesive or fastener to retain the intermediate member 306 in place may not be required. Rather, the intermediate member 306 may be sandwiched between the first molded layer 302 and the second molded layer 308.

As a further result of the compression molding process, the second molded layer 308 may retain its form, despite the second mating mold member 210 being removed therefrom. Thus, the shape of a first surface of the second molded layer 308, referred to hereinafter as an upper surface 308a for purposes of simplicity based on the illustrated example orientation, may define a configuration dictated by a molding surface 210a (see, FIG. 10) of the second mating mold member 210. In this regard, in the illustrated embodiment the second molded layer 308 includes an indentation 310 defined therein. The indentation 310 may be defined by a second mating protrusion 214 extending from the molding surface 210a (see, FIG. 10) of the second mating mold member 210.

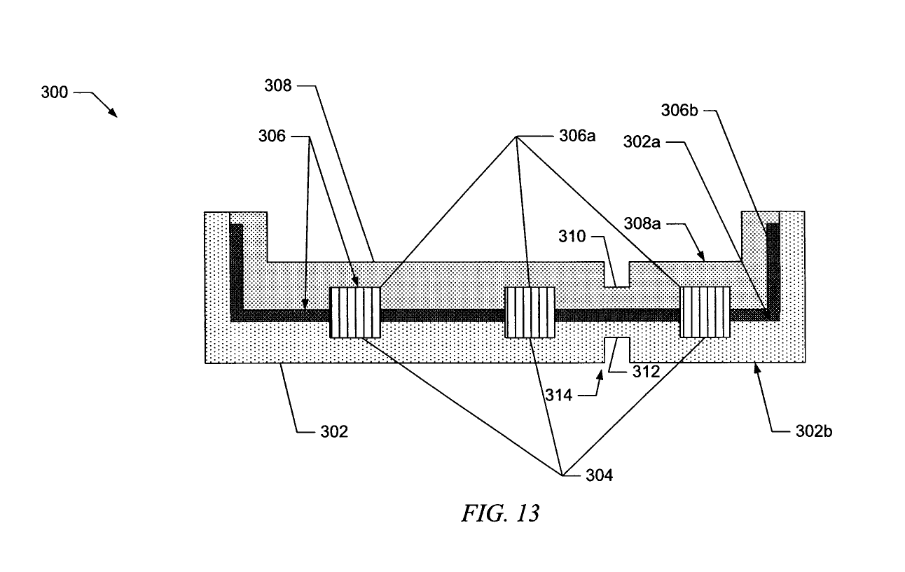

Further, the mold member 202 may be removed such that a composite structure 300 formed by the mold 200 is fully exposed, as illustrated in FIG. 13. As illustrated, the shape of a second surface of the first molded layer 302, referred to hereinafter as a lower surface 302b for purposes of simplicity based on the illustrated example orientation, may define a configuration dictated by a molding surface 202a (see, FIG. 2) of the mold member 202. In this regard, in the illustrated embodiment the first molded layer 302 includes an indentation 312 defined therein. The indentation 312 may be defined by a protrusion 216 extending from the molding surface 202a (see, FIG. 2) of the mold member 202.

The indentation 310 defined in the upper surface 308a of the second molded layer 308 and the indentation 312 defined in the lower surface 302b of the first molded layer 302 may cooperatively define a hinge 314. In this regard, a reduced material thickness between the indentations 310, 312 may facilitate bending of the composite structure 300. Note, however, that a single indentation may be employed in other embodiments to define a hinge and facilitate bending. For example, the indentation 310 defined at the upper surface 308a of the second molded layer 308 may facilitate an upward bending of the composite structure 300, in terms of the illustrated orientation. Conversely, the indentation 312 defined at the lower surface 302b of the first molded layer 302 may facilitate bending of the composite structure 300 in an opposing downward direction, in terms of the illustrated orientation.

Note that following removal of the composite structure 300 from the mold 200, certain optional additional operations may be performed thereon. In this regard, by way of example, any seams resulting from the molding process (e.g., at an interface between the mold member 202 and the second mating mold member 210) may be removed via, for example, sanding or polishing. Additionally, the composite structure 300 may be subjected to additional operations such as drilling or milling to define any additional desired features. However, as may be understood, such features may alternatively be defined by the molding process itself.

Further, in some embodiments the composite structure may undergo a magnetization process to magnetize ferromagnetic material therein. Such a magnetization process may be employed to initially magnetize any ferromagnetic material in the composite structure 300. Alternatively, the magnetization process may be employed to renew a magnetization of magnets in the composite structure 300 which may be adversely affected by heat involved in the compression molding process.

As noted above, in some embodiments the first mixture 108a and the second mixture 108b (see, FIG. 1) may be the same. In embodiments in which the first mixture 108a and the second mixture 108b are the same, substantially an entirety of the exterior of the composite structure (see, FIG. 13) may define the same properties, including physical appearance. Thus, for example, the composite structure 300 may define a pleasing continuous external appearance. In contrast products formed from leather may necessarily include an aesthetically undesirable seam.

However, in other embodiments the first mixture 108a may be different from the second mixture 108b. By employing a differing first mixture 108a and second mixture 108b, the composite structure 300 may define differing properties at the first molded layer 302 and the second molded layer 308. Thus, for example, the physical appearance of the first molded layer 302 and the second molded layer 308 may differ. However, any other properties of the first molded layer 302 and the second molded layer 308 may additionally or alternatively differ, such as elasticity, hardness, etc. Accordingly, the first mixture 108a and the second mixture 108b may be particularly selected to define a first molded layer 302 and a second molded layer 308 having desired properties. By way of further example, in one embodiment one of the molded layers 302, 308 may include fibers that are strong in tension, whereas the other molded layer may not have such fibers. Accordingly, the composite structure may be configured to resist bending in one direction, but not the opposite direction.

Further, the material composition of the first molded layer 302 and the second molded layer 308 may vary across the length or thickness thereof. In this regard, in some embodiments the first molded layer 302 and/or the second molded layer 308 may be formed from multiple mixtures, which may be poured or otherwise positioned within the mold 200 so as to provide the first molded layer and/or the second molded layer with differing characteristics across the length and/or thickness thereof. In this regard, by way of example, a mixture configured to provide relatively greater flexibility may be positioned at areas subjected to bending, such as at a hinge, whereas a mixture configured to provide relatively greater stiffness may be positioned at areas where bending is not desired. Accordingly, as may be understood, the material composition of the first molded layer 302 and the second molded layer 308 may vary so as to provide desirable material properties at the desired locations.

In addition, the mold 200 may be particularly configured to provide varying thicknesses of the first molded layer 302 and the second molded layer 308. For example, as described above, indentations 310, 312 may be defined therein. In addition to features such as indentations, embossed features and various other shapes may be defined by the mold 200 as desired. In contrast, it may be relatively difficult to cut a sheet of leather to define a varying thickness or otherwise define complex geometries.

Numerous products may be produced by the above-described molding process. By way of example, a cover for a tablet computing device or smartphone may be provided which includes molded in hinges and magnetics, without any edges. Further, a case for a tablet computing device or smartphone may include a molded in bucket configured to receive the electronic device, hinges, and magnetics.

In an additional embodiment the composite structure may define a housing for an electronic device (e.g., a tablet, smartphone, or laptop). In this regard, the composite structure may define standoffs configured for attachment to electronic components thereof, such as a display, a power supply, batteries, a processor, etc. Further, the intermediate member may include a metallic mesh that provides electromagnetic shielding. Thus, for example, a housing for a laptop may be configured as a single piece, formed from the first molded layer, the second molded layer, and the optional intermediate member. Thereby, a hinge (e.g., comprising one or more indentations) may be defined between two portions of the housing to allow for opening and closing of the laptop. Further, the elastic properties of leather may provide desirable shock resistance, in comparison to plastic and metals typically employed in housings, which tend to transmit shock.

The particular material composition of the first mixture 108a and the second mixture 108b may vary. However, in some embodiments the leather particles may preferably include at least about 50% of at least one of the first mixture 108a and the second mixture 108b, more preferably at least about 75% of at least one of the first mixture and the second mixture, and most preferably at least about 90% of at least one of the first mixture and the second mixture, which may be measured by weight or volume. In this regard, usage of a greater percentage of leather particles may provide an appearance and feel more similar to leather sheets. In one embodiment one of the first mixture 108a and the second mixture 108b may include 90% leather particles, 5% binding agent, and 5% structural fibers. In an embodiment configured for high flexibility, a mixture may include 90% leather particles, 5% latex-based adhesive, and 5% chopped fiberglass, and an intermediate member may include aramid fibers aligned with a neutral axis. In an embodiment configured for high stiffness, a mixture may include 90% leather particles, 5% epoxy adhesive, and 5% chopped carbon fibers, and an intermediate member may include carbon directional fibers aligned with a neutral axis. In an embodiment configured for electromagnetic shielding and housings, a mixture may include 90% leather particles, 5% contact cement, and 5% chopped VECTRAN® fibers, and an intermediate member may include a stainless steel mesh located at a neutral axis.

Note that bonded leather is distinguishable from the embodiments of composite structures provided herein. In this regard, bonded leather is typically formed from scraps of leather bonded together and then bonded to a roll of a substrate such as paper. In contrast, the composite structures provided herein are formed from moldable mixtures without necessarily including a substrate.

Although the present disclosure is generally described herein in terms of formation of composite structures from natural leather, it should be understood that the methods, computer program products, and composite structures described herein may include materials other than leather in other embodiments. In this regard, the two-stage molding process described herein may be employed to form composite structures from any of various other materials that may define a particulate form, and hence may be mixed with a binding agent and structural fibers to form a mixture suitable for molding as described herein. For example, various textile materials may be employed in place of, or in addition to, leather. However, as noted above, usage of leather may provide advantages in a number of respects including, for example, a desirable appearance.

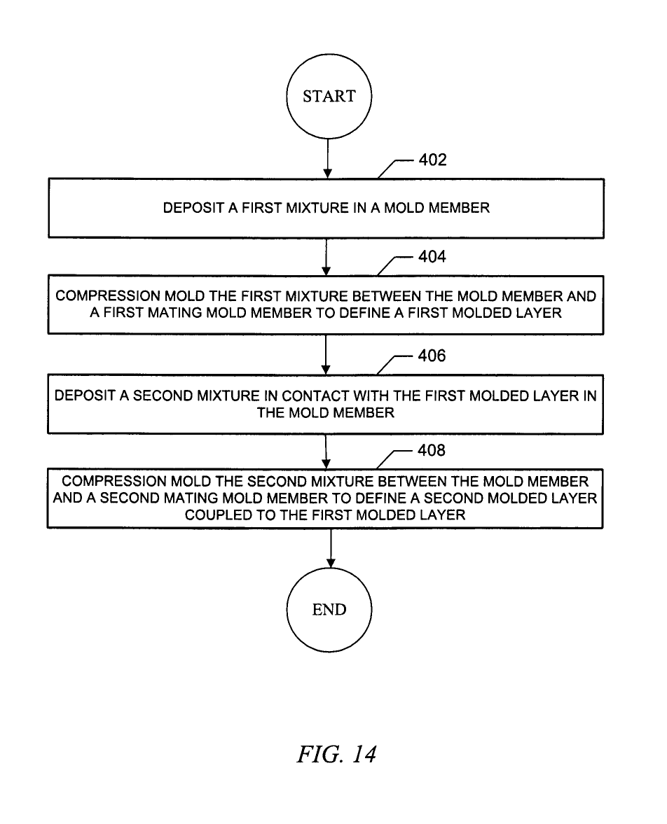

A method for forming a composite structure is also provided. As illustrated in FIG. 14, the method may include depositing a first mixture in a mold member at operation 402. Further, the method may include compression molding the first mixture between the mold member and a first mating mold member to define a first molded layer at operation 404. The method may also include depositing a second mixture in contact with the first molded layer in the mold member at operation 406. Additionally, the method may include compression molding the second mixture between the mold member and a second mating mold member to define a second molded layer coupled to the first molded layer at operation 408. At least one of the first mixture and the second mixture may include a plurality of leather particles.

In some embodiments compression molding the second mixture at operation 408 may include compression molding the second mixture between the first molded layer and the second mating mold member. The method may additionally include depositing an intermediate member in contact with the first molded layer. Depositing the intermediate member may include substantially aligning a plurality of directional fibers with a neutral axis. Compression molding the first mixture at operation 404 may include defining a pocket configured to receive the intermediate member in the first molded layer. Compression molding the first mixture at operation 404 may include forming an indentation in the first molded layer, the indentation being configured to define a hinge.

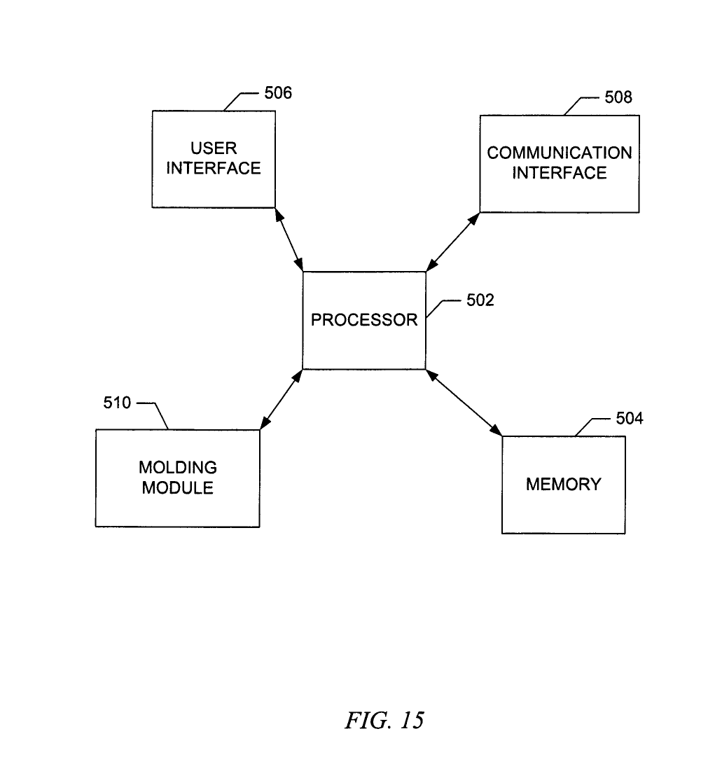

FIG. 15 is a block diagram of an electronic device 500 suitable for use with the described embodiments. In one example embodiment the electronic device 500 may be embodied in or as a controller configured for controlling compression molding operations as disclosed herein. In this regard, the electronic device 500 may be configured to control or execute the above-described compression molding operations employing the mold 200.

The electronic device 500 illustrates circuitry of a representative computing device. The electronic device 500 may include a processor 502 that may be microprocessor or controller for controlling the overall operation of the electronic device 500. In one embodiment the processor 502 may be particularly configured to perform the functions described herein relating formation of a composite structure using a mold. The electronic device 500 may also include a memory device 504. The memory device 504 a non-transitory computer readable medium that may be, for example, volatile and/or non-volatile memory. The memory device 504 may be configured to store computer code, information, data, files, applications, instructions or the like. For example, the memory device 504 could be configured to buffer input data for processing by the processor 502. Additionally or alternatively, the memory device 504 may be configured to store instructions for execution by the processor 502.

The electronic device 500 may also include a user interface 506 that allows a user of the electronic device 500 to interact with the electronic device. For example, the user interface 506 can take a variety of forms, such as a button, keypad, dial, touch screen, audio input interface, visual/image capture input interface, input in the form of sensor data, etc. Still further, the user interface 506 may be configured to output information to the user through a display, speaker, or other output device. A communication interface 508 may provide for transmitting and receiving data through, for example, a wired or wireless network such as a local area network (LAN), a metropolitan area network (MAN), and/or a wide area network (WAN), for example, the Internet.

The electronic device 500 may also include a molding module 510. The processor 502 may be embodied as, include or otherwise control the molding module 510. The molding module 510 may be configured for controlling or executing the molding operations as discussed herein.

In this regard, for example, in one embodiment a computer program product comprising at least one computer-readable storage medium having computer-executable program code portions stored therein is provided. The computer-executable program code portions, which may be stored in the memory device 504, may include program code instructions for performing the molding operations disclosed herein, including one or more of the operations described above in reference to FIG. 14, and may be executed via a processor such as the processor 502.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

1. A method for forming a composite structure, comprising:
depositing a first mixture in a mold member;
compression molding the first mixture between the mold member and a first mating mold member to define a first molded layer;
depositing a second mixture in contact with the first molded layer in the mold member; and
compression molding the second mixture between the mold member and a second mating mold member to define a second molded layer coupled to the first molded layer,
wherein at least one of the first mixture and the second mixture comprises a plurality of leather particles.

2. The method of claim 1, wherein compression molding the second mixture comprises compression molding the second mixture between the first molded layer and the second mating mold member.

3. The method of claim 1, further comprising depositing an intermediate member in contact with the first molded layer.

4. (canceled)

5. The method of claim 3, wherein compression molding the first mixture comprises defining a pocket configured to receive the intermediate member in the first molded layer.

6.-12. (canceled)

13. A composite structure, comprising:
a first molded layer formed from a first mixture;
a second molded layer formed from a second mixture and coupled to the first molded layer; and
an intermediate member positioned between and substantially enclosed by the first molded layer and the second molded layer,
wherein at least one of the first mixture and the second mixture comprises a plurality of leather particles.

14. The composite structure of claim 13, wherein at least one of the first mixture and the second mixture comprises a plurality of support fibers.

15. The composite structure of claim 13, wherein at least one of the first mixture and the second mixture comprises a binding agent.

16. The composite structure of claim 13, wherein the intermediate member is selected from a group consisting of:
a ferromagnetic material;
a plurality of directional fibers;
a plate; and
a mesh.

17. The composite structure of claim 13 configured as a cover, case, or a housing for an electronic device.

18. The composite structure of claim 13, comprising a hinge defined by a protrusion in at least one of the first molded layer and the second molded layer.

19.-22. (canceled)

23. A cover for an electronic device, the cover comprising:
a first layer formed from a first mixture, the first mixture comprising:
a first plurality of leather particles;
a first plurality of structural fibers; and
a first binding agent;
a second layer formed from a second mixture, the second mixture comprising:
a second plurality of leather particles;
a second plurality of structural fibers;
a second binding agent; and
an intermediate layer bounded and enclosed by the first layer and the second layer.

24. The cover of claim 23, the first layer further comprises a first indention on a first surface of the first layer, and a first cavity on a second surface of the first layer, the second surface different from the first surface.

25. The cover of claim 24, the second layer further comprising a first indention on a first surface of the second layer, the second surface different from the first surface.

26. The cover of claim 25, wherein the first cavity of the first layer and the first cavity of the second layer receive the intermediate layer.

27. The cover of claim 26, wherein the first indention of the first layer and the first indention of the second layer define a hinge.

28. The cover of claim 24, wherein the intermediate layer includes a magnetic material.

29. The composite structure of claim 13, wherein the intermediate member a plurality of directional fibers aligned with respect to a neutral axis.

30. The composite structure of claim 13, wherein the first mixture comprises defines a pocket configured to receive the intermediate member in the first molded layer.

31. The method of claim 13, wherein the intermediate member is a magnet enclosed and bounded the first molded layer and the second molded layer.

32. The method of claim 13, wherein the first mixture comprises a leather material, a plurality of structural fibers, and a binding agent.
